(19) United States
(12) Patent Application Publication
(10) Pub. No.: US 2010/0253502 A1
(43) Pub. Date: Oct. 7, 2010

(54) PRODUCT LOCATOR AND METHOD FOR LOCATING A PRODUCT

(76) Inventor: Susan DUNCAN, Scarsdale, NY (US)

Correspondence Address: ARENT FOX LLP, 1050 CONNECTICUT AVENUE, N.W., SUITE 400, WASHINGTON, DC, 20036, US

(21) Appl. No.: 12/652,580

(22) Filed: Jan. 5, 2010

Related U.S. Application Data
(60) Provisional application No. 61/142,450, filed on Jan. 5, 2009.

(51) Int. Cl. G08B 1/08

(52) U.S. Cl. 340/539.1

(57) ABSTRACT

An item locator for locating an item comprising a receiver for receiving a wireless signal, including a specific code, a memory for storing a programmed code, a comparator for comparing the received specific code and the programmed code, and an alerter for outputting an alert signal when the received specific code and the programmed code match. The item locator may be a separate device or built-into the item. The wireless signal may be transmitted from a landline telephone, cellular telephone, a computer, an iPod, Bluetooth device (with or without the programmed code) or a blackberry, for example.

This application claims priority from U.S. Provisional Patent Application Ser. No. 61/142,450 entitled “Product Locator and Method for Locating a Product”, filed Jan. 5, 2009. This application is incorporated by reference herein in its entirety.

### BACKGROUND OF THE INVENTION

1. Field of the Invention

Aspects of the present invention relate to a product locator and method for locating a product, and more particularly, to a locator and method using a wireless communication technology to locate a lost, misplaced or missing product.

2. Background of the Related Art

Many people have encountered losses of smaller items, such as cellular telephones, keys, blackberries, iPod, etc. due to their small size and light volume. To avoid losing smaller items, some people keep a duplicate item (such as a key) in a secured place or carry them (such as cellular telephones and blackberries) at all times. A lost cellular telephone may be located by calling the cellular telephone number from a separate telephone line. However, such a method will not work if the cellular telephone was turned off at the time when it was lost or if it ran out of battery, for example.

There is a need in the art for methods and apparatuses that are capable of locating a lost, displaced or missing product more efficiently by using wireless/cellular telephone communications technology.

### SUMMARY OF THE INVENTION

Aspects of the present invention address the above identified needs, as well as others, by providing a code receiver on a product that vibrates or rings when receiving an initiated signal from a cellular telephone or a landline telephone.

Specifically, aspects of the invention solve the above needs, and others, by using wired or wireless telephone communication technologies. Aspects of the present invention incorporate landline telephone/cellular telephone communication standards to set up a programmed code for each item locator. The item locator is then attached to an item that requires special attention. The item locator may include, for example, a code receiver that receives a call that transmits a code matching with the code programmed in the item locator. Upon receiving the matching code, the item locator is activated and outputs alert signals, such as vibrations, sounds, or lights, to notify a user.

Additional advantages and novel features of various aspects of the present invention will be set forth in part in the description that follows, and in part will become more apparent to those skilled in the art upon examination of the following or upon learning by practice thereof.

### BRIEF DESCRIPTION OF THE DRAWINGS

FIG. 1 illustrates a block diagram of an exemplary product locator in accordance with aspects of the present invention.

FIG. 2 illustrates an exemplary system diagram for locating an item by use of a telephone system to activate an item locator that is attached to the item, in accordance with aspects of the present invention.

FIG. 3 presents an exemplary method for locating an item by use of a telecommunications signal, in accordance with aspects of the present invention.

FIG. 4 presents an exemplary system diagram of various hardware components and other features, for use in accordance with aspects of the present invention; and

FIG. 5 is a block diagram of various exemplary system components, in accordance with aspects of the present invention.

### DETAILED DESCRIPTION OF THE INVENTION

The detailed description set forth below in connection with the appended drawings is intended as a description of various aspects of the present invention and is not intended to represent all aspects in which variations of the present invention may be practiced. The detailed description includes specific details for the purpose of providing a thorough understanding of aspects of the present invention. However, it will be apparent to those skilled in the art that many variations may be practiced without these specific details. In some instances, well-known structures and components are shown in block diagram form in order to avoid obscuring concepts in accordance with aspects of the present invention.

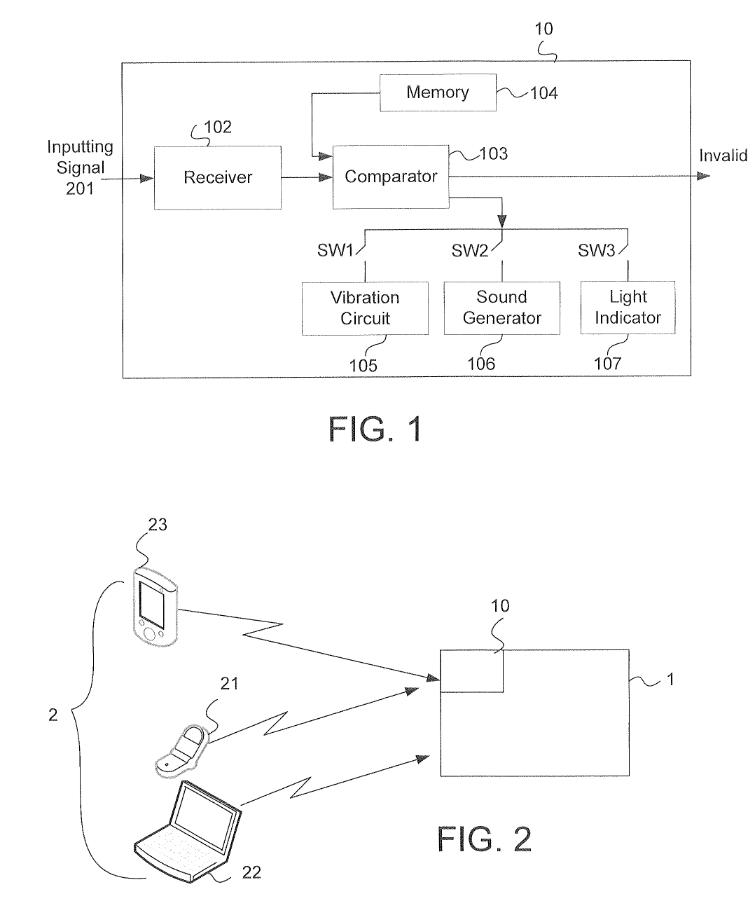

An exemplary item locator 10 in accordance with one exemplary variation of the present invention is illustrated in FIG. 1. The item locator 10 may be a tangible article attached to an item that requires attention, such as a cellular telephone, a key, a blackberry, etc. In other cases, the item locator 10 may also be or include a device or software that is built into an item of manufacture. In either case, the item locator 10 may receive a wireless communications signal 201 including a specific code, and according to the signal, be activated to output an alert signal.

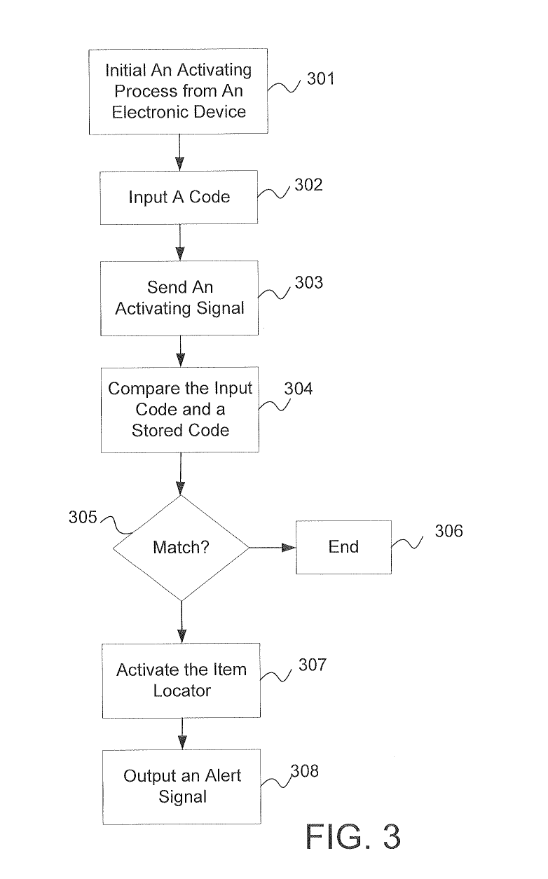

FIG. 2 illustrates an exemplary system diagram showing how the item locator 10 can be located by an electronic device, in accordance with aspects of the present invention. In this figure, the item locator 10 is attached or built in an item 1. In accordance with this exemplary variation of the present invention, an electronic device 2 may represent any type of electronic device, such as a wireless/landline telephone system 21, a computer 22, or a blackberry 23, which is capable of transmitting a wired and/or wireless radio communication signal carrying data, such as a code. In the example of using a telephone 21 to locate the item locator 2, a user makes a telephone call and inputs a specific code preprogrammed for the item locator 10. The telephone call may be a call with a specific telephone number or an existing telephone number of the user, such as the user's home telephone number, that is set up when the item locator 10 is initialized. In either case, after the telephone call is connected, the signal 201 carrying the specific code is transmitted to the item locator 10 from the telephone 2. Upon receipt of the signal 201, the item locator 10 is activated when the specific code matches a predetermined code stored in the locator 10. An alert signal is then outputted accordingly.

The user may also transmit the code to the item locator 10 through, for example, a computer 22, a blackberry 23, an iPod (not shown), and so on, by accessing a specific website or by sending an email. In accordance with aspects of the present invention, the code may be sent by a variety of devices, so long as such devices are capable of approximately transmitting a data signal.

Now referring to FIG. 1, the item locator 10 may include a memory 101 for storing the predetermined code and/or other commands, a receiver 102 for receiving the input signal 201, a comparator 103, a memory 104 for storing the predetermined code, and one or more of a vibration circuit 105 for outputting vibration signals, a sound generator 106 for generating alert sounds, and/or a light indicator 107 for emitting light. In one variation, the light may be a flashing light. In an alternative variation, the light may be a steady light with a specific color. Variations of the item locator 10 may also include one or more switches SW1, SW2, SW3 for switching an alert mode to at least one of the vibration circuit 103, the sound generator 102, and/or the light indicator 105. In accordance with aspects of the invention, the mode switching may be pre-set by a user.

The predetermined code stored in the item locator 10 may be set up by a user and is changeable. The predetermined code may also be built-in by a manufacturer and thus cannot be changed or may be changed by the use upon authorization. The input wireless communications signal 201 may be transmitted from a cellular telephone, a landline telephone, a blackberry, a computer, a pager or similar devices, for example, that are capable of transmitting wireless data signals.

In accordance with one variation of the present invention, after the code receiver 102 receives the communications signal 201, the comparator 103 compares the specific code contained in the telecommunication signal 201 and the predetermined code stored in the memory 101 and outputs an invalid signal when the codes do not match, and a valid signal when the codes match each other. When it is determined that the received signal is invalid, no activation will take effect on the item locator 10 and the item locator 10 will simply discard such incoming signal. On the other hand, when it is determined that the received signal is valid, the item locator 10 will be activated to output an alert signal. Based on the setup of the user, the alert signal may be at least one of a vibration generated by the vibration circuit 104, sound generated by the sound generator 105, and/or light generated by the light indicator 106.

FIG. 3 is a block diagram illustrating a method for locating a missing item, in accordance with aspects of the present invention. At step 301, a user initiates a telephone call by dialing a telephone number or an activating process from an electronic device. Once the activating process/call is initiated, at step 302, the user is prompted to input a specific code that is preprogrammed for an item locator that is attached to or otherwise associated with a missing item. At step 303, upon receiving the input code, the telephone or electronic device then composes an activating signal by combining the dialed telephone number/activating process and the specific code inputted by the user, and then transmits the activating signal through a wired/wireless telecommunication network.

At step 304, the activating signal is received by the item locator. The item locator retrieves the predetermined code stored in the memory and compares the predetermined code with the specific code carried by the activating signal. At step 305, it is determined whether these codes match each other. If the answer is “NO”, the activating signal will be discarded and no activation will be taken place, at step 306.

If the predetermined code stored in the item locator matches the specific code received by the item locator, the item locator is activated, at step 307. Accordingly, based on the setup model of the item locator, the item locator outputs at least one of a vibration signal, a sound including a beep, music, and/or voice, and/or a light signal, including a flashing light, a light with a specific color, a running light, etc. Exemplary variations of the present invention may allow more than one type of alerting. For example, the item locator may output both the vibration signal and the sound signal, may output both the sound signal and the light signal, may output both the light signal and the vibration signal, or may output all three types of the above alerting signals.

The item locator in accordance with aspects of the present invention may also use Bluetooth technology. In this example, the telephone, computer, or other electronic devices and the item locator are equipped with Bluetooth capability. Prior to use, the electronic device and the item locator are required to establish a Bluetooth communication by assigning a master device and a slave device and setting communicable codes. One exemplary variation of the present invention is to assign the telephone, the computer, or the electronic device that may be used to locate the item locator as the master device and to assign the item locator as the slave device. According to Bluetooth communication technology, when the item locator is simply within a receivable distance from the master device, the Bluetooth communication will be automatically connected and an alert signal thereby generated. Therefore, the item locator can be easily located when the Bluetooth communication is completed.

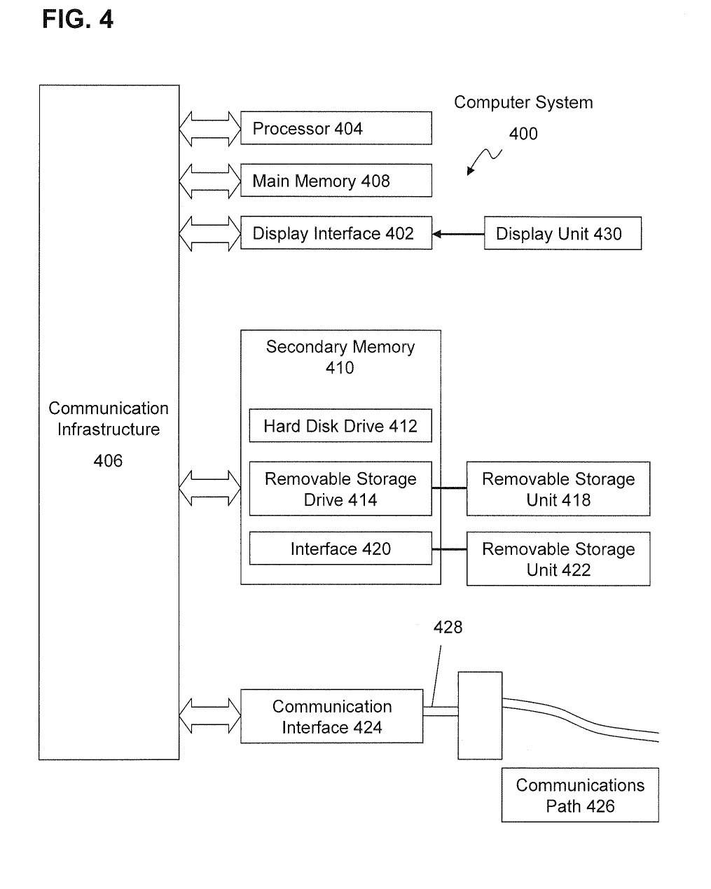

Variations of the present invention may be implemented using hardware, software, or a combination thereof and may be implemented in one or more computer systems or other processing systems. In one variation, aspects of the present invention are directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). Various software variations are described in terms of this exemplary computer system. After reading this description, it will become apparent to a person skilled in the relevant art(s) how to implement aspects of the present invention using other computer systems and/or architectures.

Computer system 400 can include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

In alternative variations, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 480, a hard disk installed in hard disk drive 470, and signals 428. These computer program products provide software to the computer system 400. Aspects of the present invention are directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of various aspects of the present invention, as discussed herein. In particular, the computer programs, when executed, enable the processor 410 to perform such features. Accordingly, such computer programs represent controllers of the computer system 400.

In one variation of the present invention, which is implemented using software, the software may be stored in a computer program product and loaded into computer system 400 using removable storage drive 414, hard drive 412, or communications interface 420. The control logic (software), when executed by the processor 404, causes the processor 404 to perform the functions of the invention as described herein. Another variation is implemented primarily in hardware using, for example, hardware components, such as application specific integrated circuits (ASICs). Implementation of the hardware state machine so as to perform the functions described herein will be apparent to persons skilled in the relevant art(s).

In yet another variation, aspects of the present invention are implemented using a combination of both hardware and software.

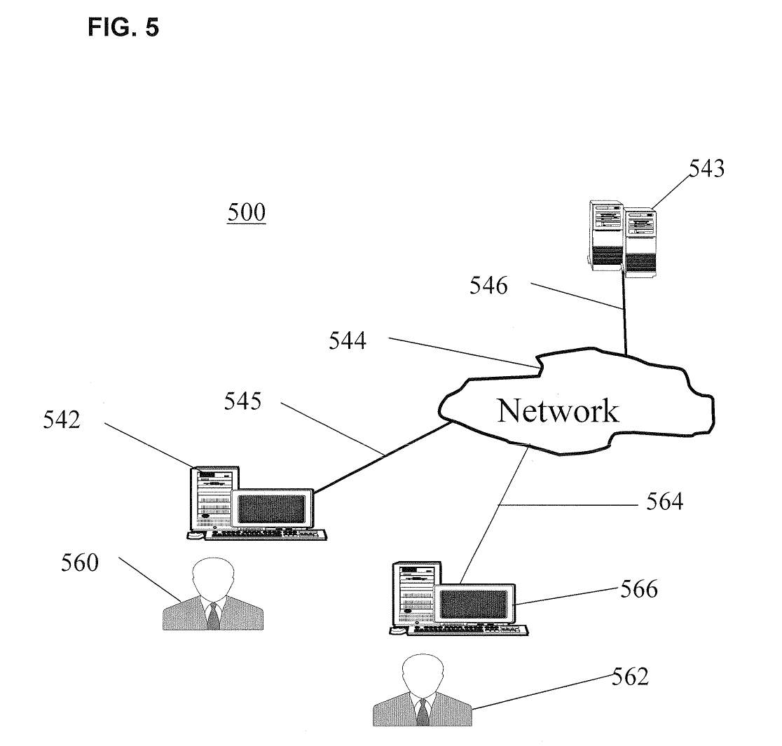

FIG. 5 shows a communication system 500 usable in accordance with aspects of the present invention. The communication system 500 includes one or more users 560, 562 (also referred to interchangeably herein as one or more “accessors”) and one or more mobile devices 542, 566. In one variation, data for use in accordance with aspects of the present invention is, for example, downloaded and/or accessed by users 560, 564 via terminals 542, 566, such as laptop computers or wireless devices, including personal digital assistants (PDAs) or other hand-held wireless devices, coupled to a server 543, such as a laptop computer, mobile telephone or other device having a processor and a repository for data and/or connection to a repository for data, via, for example, a network 544, such as the Internet or an intranet, and couplings 545, 546, 564. The couplings 545, 546, 564 may include, for example, wired, wireless, or fiberoptic links. In another variation, the method and system operate in a stand-alone environment, such as on a single mobile device.

While aspects of the present invention have been described in connection with various features, it will be understood by those skilled in the art that variations and modifications of such aspects described above may be made without departing from the scope thereof. Other aspects will be apparent to those skilled in the art from a consideration of the specification or from a practice thereof.

What is claimed is:

1. An item locator, comprising:
a receiver for receiving a wireless signal including a specific code;
a memory for storing a programmed code;
a comparator for comparing the received specific code and the programmed code; and
an alerter for outputting an alert signal when the received specific code and the programmed code match.

2. The item locator of claim 1, wherein the item locator is attached to or coupled to an item.

3. The item locator of claim 1, wherein the item locator is built-into an item.

4. The item locator of claim 1, wherein the alert signal includes at least one selected from a group consisting of a vibration, a sound, and a light emission.

5. The item locator of claim 1, wherein the programmed code is programmable by a user.

6. The item locator of claim 1, wherein the programmed code is programmable by a manufacturer of the item locator.

7. The item locator of claim 1, wherein the wireless signal is received via at least one selected from a group consisting of a landline telephone signal, a cellular telephone signal, a radio communication signal, and a computer wireless signal.

8. A method for locating an item, comprising:
setting up a programmed code for an item locator;
associating the item locator with the item;
transmitting a wireless signal including a specific code to the item locator;
comparing the specific code and the programmed code stored in the item locator; and
outputting an alert signal when the specific code and the programmed code match.

9. The method of claim 8, further comprising:
activating the item locator when the specific code and the programmed code match.

10. The method of claim 9, wherein the item locator outputs the alert signal.

11. The method of claim 10, wherein the alert signal includes at least one selected from a group consisting of a vibration, a sound, and a light.

12. The method of claim 8, wherein the wireless signal is initiated by one selected from a group consisting of a landline telephone, a cellular telephone, a computer, an iPod, a Bluetooth system, and an email system.
